(19) United States
(12) Patent Application Publication
(10) Pub. No.: US 2021/0173522 A1
(43) Pub. Date: Jun. 10, 2021

(54) TOUCH PANEL AND TOUCH DEVICE

(71) Applicants: BOE TECHNOLOGY GROUP CO., LTD., Beijing (CN); Hefei Xinsheng Optoelectronics Technology Co., Ltd., Anhui (CN)

(72) Inventors: Xiaodong XIE, Beijing (CN); Ming ZHANG, Beijing (CN); Jing WANG, Beijing (CN); Jian TIAN, Beijing (CN); Qingpu WANG, Beijing (CN)

(21) Appl. No.: 15/779,687

(22) PCT Filed: Sep. 29, 2017
(86) PCT No.: PCT/CN2017/104617

§ 371 Date: May 29, 2018

(30) Foreign Application Priority Data
Mar. 10, 2017 (CN) 201720232208.5

(51) Int. Cl. G06F 3/044; G06F 3/041

(52) U.S. Cl. CPC G06F 3/0446; G06F 2203/04111; G06F 3/0412; G06F 3/0445

(57) ABSTRACT

The present disclosure discloses a touch panel and a touch device. The touch panel includes a substrate and a conductive layer. The substrate includes a first surface. The conductive layer is formed on the first surface and includes a first conductive layer and a second conductive layer spaced apart from each other. The first conductive layer is provided with a first-direction line and a second-direction line coupled to each other, and the second conductive layer is provided a third-direction line and a fourth-direction line coupled to each other. At least one of the first-direction line, the second-direction line, the third-direction and the fourth-direction line is provided with a plurality of curves.

### CROSS-REFERENCE

The present application is based upon International Application No. PCT/CN2017/104617, filed on Sep. 29, 2017, which is based upon and claims priority to Chinese Patent Application No. 201720232208.5, titled “TOUCH PANEL AND TOUCH DEVICE”, filed on Mar. 10, 2017, the entire contents of which are incorporated herein by reference.

### TECHNICAL FIELD

The present disclosure generally relates to a touch technology, and in particular, to a touch panel. Further, the present disclosure relates to a touch device.

### BACKGROUND

With the development of display technology, the display panel has gradually entered a high resolution period, and the PPI (Pixels Per Inch) of the display panel is gradually increased. On the other hand, the touch technology has become increasingly popular in electronic products such as mobile phones, tablet computers, and notebook computers as the continuous development thereof.

The touch technology generally includes optical, resistive, capacitive, and electromagnetic touch technologies. The capacitive touch technology is widely used due to its low cost and excellent user experience. For example, the capacitive touch screen of Apple Inc. is very popular due to its excellent touch function. At present, to keep up with the Apply Inc., many touch screens have been launched on the market. With the development of touch screens, people have increasingly higher demands on their optical and electrical performances and appearance.

At present, the touch technology is generally applied to mobile phones, tablet computers, and notebook computers in the capacitive touch screen industry. With the popularity of such capacitive touch screen, people have more and more expectation for the same. As a popular technology on the market today, passive pens, active pens or electromagnetic pens EMR are applied to these products, and such products with the pens have good market competitiveness. The Microsoft's operating system becomes stricter with the passive pens as it was upgraded from Win 8 to Win10, which would benefit the consumers more and allow them to experience the latest high-techs.

The two-in-one product combing a tablet and a notebook computer and having metal meshes (metal grids) is popular in the market today. The two-in-one product has excellent touch experience and impressive active pens, which enhances the competitiveness thereof. Such touch product with metal meshes has high requirements for the electrical performance and appearance of the product. The regular metal meshes may cause light generated by a light source of a display module to have a moire pattern, which problem keeps troubling people.

The information disclosed in the above described background portion is only for enhancing the understanding of the background of the present disclosure, and thus, it may contain information that does not form the prior art known by those ordinary skilled in the art.

### SUMMARY

The part is intended to neither define the key feature and the essential technical feature of the claimed technical solution, nor determine the protection scope of the claimed technical solution.

According to an aspect of the present disclosure, there is provided a touch panel, including a substrate and a conductive layer. The substrate includes a first surface. The conductive layer is formed on the first surface and includes a first conductive layer and a second conductive layer spaced apart from each other. The first conductive layer is provided with a first-direction line and a second-direction line coupled to each other, and the second conductive layer is provided a third-direction line and a fourth-direction line coupled to each other. At least one of the first-direction line, the second-direction line, the third-direction and the fourth-direction line is provided with a plurality of curves.

According to an embodiment of the present disclosure, a projection of the curve on the first surface is non-linear.

According to an embodiment of the present disclosure, the conductive layer further includes an insulating layer. The first conductive layer is coated on the first surface, the insulating layer is disposed on a surface of the first conductive layer away from the first surface, and the second conductive layer is disposed on a surface of the insulating layer away from the first conductive layer, so that the second conductive layer is spaced apart from the first conductive layer.

According to an embodiment of the present disclosure, the first-direction line and the second-direction line are coupled at a first node, the third-direction line and the fourth-direction line are coupled at a second node, and a projection of the conductive layer on the first surface is formed so that the first node and second node are interlaced with each other.

According to an embodiment of the present disclosure, there are a plurality of the first-direction lines equally spaced, a plurality of the second-direction lines equally spaced, a plurality of the third-direction lines equally spaced, and a plurality of the fourth-direction lines equally spaced.

According to an embodiment of the present disclosure, the first-direction line is provided with a plurality of the curves equally spaced, the second-direction line is provided with a plurality of the curves equally spaced, the third-direction line is provided with a plurality of the curves equally spaced, and the fourth-direction line is provided with a plurality of the curves equally spaced.

According to an embodiment of the present disclosure, a projection of the conductive layer on the first surface is formed into grid units, and each of the grid units is provided with at least one of the curves.

According to an embodiment of the present disclosure, each of grid sides of the grid unit is provided with at least one of the curves.

According to an embodiment of the present disclosure, the grid unit has a shape of parallelogram, each of the grid sides of the grid unit is provided with a same number of the curves, and the grid unit is formed in a centrosymmetric structure.

According to an embodiment of the present disclosure, the grid unit has a shape of rhombus, each of the grid sides of the grid unit is provided with a same number of the curves, and the grid unit is formed in a non-axisymmetric structure.

According to an embodiment of the present disclosure, a length of the curve is ⅛ to ½ of a length of the grid side where the curve is located.

According to another aspect of the present disclosure, there is provided a touch device, including the touch panel provided by the present disclosure.

### BRIEF DESCRIPTION OF THE DRAWINGS

Various objects, features and advantages of the present disclosure would be more obvious in consideration of the detailed description of the preferable embodiments of the present disclosure in conjunction with the drawings. The drawings are only exemplary diagrams of the present disclosure, and not necessary to be scaled. In the drawings, the same reference numerals denote the same or similar parts throughout.

FIG. 1 is a top view of a conductive layer according to an exemplary embodiment;

FIG. 2 is an enlarged partial view of a first conductive layer in FIG. 1;

FIG. 3 is an enlarged partial view of a curve in FIG. 1;

FIG. 4 is a structure view of a touch panel according to an exemplary embodiment;

FIG. 5 is a structure view of a touch panel according to another exemplary embodiment;

FIG. 6 is a top view of a conductive layer in the related art.

### DETAILED DESCRIPTION

Example embodiments now will be described more fully with reference to the accompanying drawings. However, the example embodiments can be implemented in various forms and should not be construed as being limited to the embodiments set forth herein. Rather, these embodiments are provided so that this disclosure will be thorough and complete, and will fully convey the concept of the example embodiments to those skilled in the art. The same reference numerals in the drawings denote the same or similar structures, and thus detailed description thereof will be omitted.

Unless stated otherwise, the order words such as “first, second, third, and fourth” used in the present disclosure are merely for better illustrating the technical solutions of the present disclosure and are convenient for distinguishing the same or similar components. It does not mean that the components defined by such order words have the order of priority, nor is it intended to limit the present disclosure.

FIG. 6 is a top view of a conductive layer in the related art. Referring to FIG. 6, the conductive layer in the related art includes a first line 211′ and a third line 221′ parallel to each other, and a second line 212′ and a fourth line 222′ parallel to each other. The first line 211′ and the second line 212′ are coupled to each other at a first point 4′ to be conductive. The third line 221′ and the fourth line 222′ are couplet to each other at a second point 5′ to be conductive. A grid unit formed by the first line 211′, the second line 212′, the third line 221′, and the fourth line 222′ of the conductive layer has an axisymmetric structure, and thus a regular metal mesh (metal grid) is formed. The regular metal grid may cause light generated by a module to have a moire pattern, therefore, the conductive layer in the related art has a remarkable moire phenomenon.

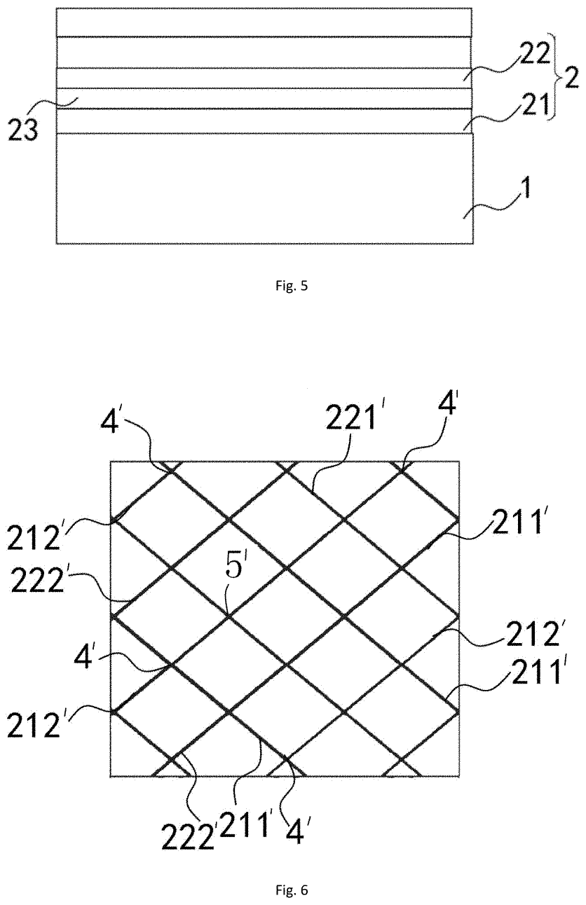

Referring to FIGS. 4 and 5, according to an aspect of the present disclosure, a touch panel is provided. The touch panel may include a substrate 1 and a conductive layer 2. The substrate 1 may include a first surface so that the conductive layer 2 may be formed on the first surface. FIGS. 4 and 5 are respectively schematic structure views of two types of touch panels.

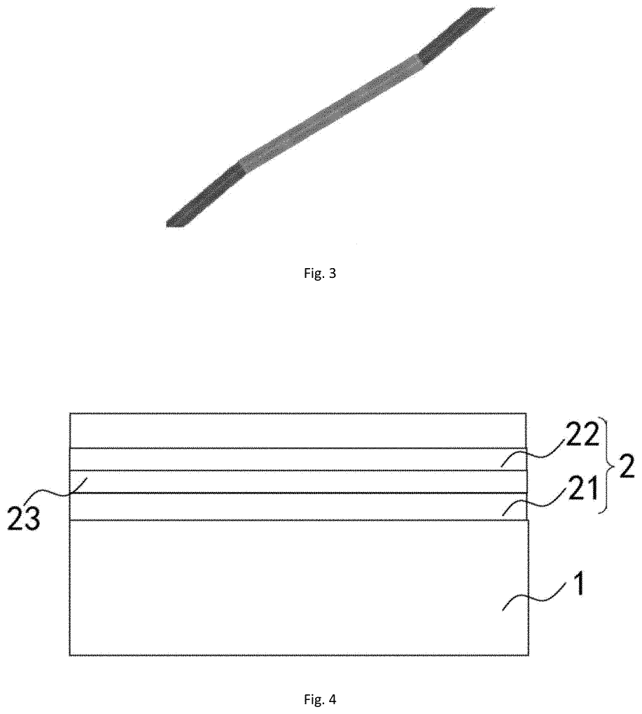

Referring to FIGS. 1 to 3, the conductive layer 2 may include a first conductive layer 21 and a second conductive layer 22 spaced apart from each other. The first conductive layer 21 is provided with a first-direction line 211 and a second-direction line 212 coupled to each other. The first-direction line 211 and the second-direction line 212 are coupled to each other so that the entire first conductive layer 21 is conductive, and the coupling point between the first-direction line 211 and second-direction line 212 is referred to as a first node 4. The second conductive layer 22 is provided with a third-direction line 221 and a fourth-direction line 222 coupled to each other. The third-direction line 221 and the fourth-direction line 222 are coupled to each other so that the entire conductive layer 22 is conductive, and the coupling point between the third-direction line 221 and the fourth-direction line 222 is referred to as a second node 5.

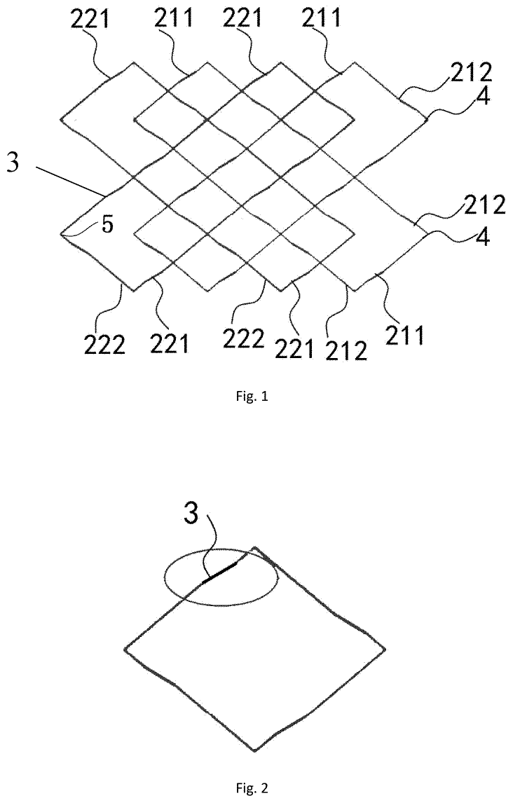

Referring to FIGS. 1 and 2, according to an embodiment of the present disclosure, a projection of the conductive layer 2 on the first surface is formed into grid units, and each of the grid units is provided with at least one curve 3, so that the grid unit is formed in an unsymmetrical structure, which may effectively disturb a space beat effect of a light source of LCD (liquid crystal display) that may be generated in the regular grid unit, and thus the effect generated by the moire may be reduced. According to an embodiment of the present disclosure, each of grid sides of the grid unit is provided with at least one curve 3. In an embodiment of the present disclosure, the grid unit may have a shape of rhombus, each of the grid sides of the grid unit is provided with a same number of the curves 3, and the grid unit may be formed in a non-axisymmetric structure. In an embodiment of the present disclosure, the grid unit may have a shape of parallelogram, each of the grid sides of the grid unit may be provided with a same number of the curves 3, and the grid unit may be formed in a centrosymmetric structure.

In a specific embodiment of the present disclosure, each of the grid sides may be provided with one curve 3. However, the present disclosure is not limited thereto, and each of the grid sides may be provided with but not limited to two, three, four or more curves 3, and the number of the curves may be determined as needed.

Referring to FIG. 1 again, in an embodiment of the present disclosure, there are a plurality of first-direction lines 211, and the plurality of first-direction lines 211 may be equally spaced. There are a plurality of second-direction lines 212, and the plurality of second-direction lines 212 may also be equally spaced. There are a plurality of third-direction lines 221, and the plurality of third-direction lines 221 may also be equally spaced. There are a plurality of fourth-direction lines 222, and the plurality of fourth-direction lines 222 may also be equally spaced. In a specific embodiment of the present disclosure, the first-direction lines 211, the second-direction lines 212, the third-direction lines 221 and the fourth-direction lines 222 are all equally spaced, so that the projections of the first and second nodes 4 and 5 on the first surface may be evenly disposed respectively. However, the present disclosure is not limited thereto, other uneven disposing also falls in the protection scope of the present disclosure, and an adjustment may be made according to the actual situation.

Referring to FIG. 1 again, in a specific embodiment of the present disclosure, a length of the curve 3 may be ⅛ to ½ of a length of the grid side of the grid unit where the curve 3 is located. In a specific embodiment of the present disclosure, the length of the curve 3 may be ⅕ to ⅓ of the length of the grid side of the grid unit where the curve 3 is located. In a specific embodiment of the present disclosure, the length of the curve 3 may be 30-60 μm, and the distance from an end of the curve 3 to the nearest node may be 40-70 μm. In a specific embodiment of the present disclosure, the distance between two adjacent grid sides parallel to each other may be 100-300 μm. In a specific embodiment of the present disclosure, the distance between two adjacent grid sides parallel to each other may be 150-210 μm.

Referring to FIG. 1 again, in an embodiment of the present disclosure, the first-direction line 211 is provided with a plurality of curves 3 equally spaced. The second-direction line 212 is provided with a plurality of curves 3 equally spaced. The third-direction line 221 is provided with a plurality of curves 3 equally spaced. The fourth-direction line 222 is provided with a plurality of curves 3 equally spaced.

At least one of the first-direction line 211, the second-direction line 212, the third-direction 221 and the fourth-direction line 222 is provided with a plurality of curves 3, so that the adjacent lines may be asymmetric to reduce or avoid the formation of moire. The curve 3 defined in the present disclosure is distinguished from the straight line extension, that is, any non-straight line extension formed on the straight line extension may be considered as a curve. The curve may be a smooth arc transition, such as but not limited to an S-shaped arc. The curve may also be a non-smooth linear structure, such as but not limited to a Z-shaped bend structure, and they are all within the scope of the present disclosure. In a specific embodiment of the present disclosure, the length of the grid side between the first node 4 and the second node 5 is greater than the length of the straight line between the first node 4 and the second node 5 due to the curve 3.

It can be understood that the technical solutions of the present disclosure may include the following technical solutions. For example, all of the first-direction line 211, the second-direction line 212, the third-direction line 221, and the fourth-direction line 222 are provided with the curve 3; optionally, any one of the first-direction line 211, the second-direction line 212, the third-direction line 221, and the fourth-direction line 222 is provided with the curve 3; optionally, any two of the first-direction line 211, the second-direction 212, the third-direction line 221, and the fourth-direction line 222 are provided with the curve 3; and optionally, any three of the first-direction line 211, the second-direction 212, the third-direction line 221, and the fourth-direction line 222 are provided with the curve 3, however the present disclosure is not limited thereto. The technical solutions set forth above and other technical solutions that are not set forth in the present disclosure but can be conceived of by those skilled in the art according to the inventive concept of the present disclosure are within the protection scope of the present disclosure.

Referring to FIGS. 1 to 3 again, in a specific embodiment of the present disclosure, the projection of the curve 3 on the first surface may be non-linear, but the present disclosure is not limited thereto. In a specific embodiment of the present disclosure, the curve 3 may be formed by performing metal plating on the substrate 1, and then forming a conductive line, such as but not limited to the above first-direction line 211, second-direction line 212, third-direction line 221 or the fourth-direction line 222, on the above plating by using an etching process.

Referring to FIGS. 4 and 5 again, in a specific embodiment of the present disclosure, the conductive layer 2 further includes an insulating layer 23, which may be disposed between the first conductive layer 21 and the second conductive layer 22. Specifically, the first conductive layer 21 may be coated on the first surface, the insulating layer 23 may be disposed on a surface of the first conductive layer 21 away from the first surface, and the second conductive layer 22 may be disposed on a surface of the insulating layer 23 away from the first conductive layer 21, so that the second conductive layer 22 may be spaced apart from the first conductive layer 21.

Referring to FIG. 1 again, in an embodiment of the present disclosure, the coupling point of the first-direction line 211 and the second-direction line 212 may be referred to as a first node 4, and the coupling point of the third-direction line 221 and the fourth-direction line 222 may be referred to as a second node 5. The projection of the conductive layer 2 on the first surface may be formed so that the first node 4 and second node 5 are interlaced with each other.

According to another aspect, there is provided a touch device including the touch panel provided by the present disclosure.

The features, structures, or characteristics described may be combined in any suitable manner in one or more embodiments. In the above description, numerous specific details are provided to provide a thorough understanding of the embodiments of the present disclosure. However, those skilled in the art will recognize that the technical solutions of the present disclosure may be practiced without one or more of the specific details described, or other methods, components, materials, etc. may be employed. In other instances, the well-known structures, materials, or operations are not shown or described in detail to avoid obscuring aspects of the present disclosure.

1. A touch panel, comprising:
a substrate, comprising a first surface; and
a conductive layer, formed on the first surface and comprising a first conductive layer and a second conductive layer spaced apart from each other, the first conductive layer being provided with a first-direction line and a second-direction line coupled to each other, and the second conductive layer being provided with a third-direction line and a fourth-direction line coupled to each other,
wherein at least one of the first-direction line, the second-direction line, the third-direction and the fourth-direction line is provided with a plurality of curves.

2. The touch panel according to claim 1, wherein a projection of the curve on the first surface is non-linear.

3. The touch panel according to claim 1, wherein the conductive layer further comprises an insulating layer, and
wherein the first conductive layer is coated on the first surface, the insulating layer is disposed on a surface of the first conductive layer away from the first surface, and the second conductive layer is disposed on a surface of the insulating layer away from the first conductive layer, so that the second conductive layer is spaced apart from the first conductive layer.

4. The touch panel according to claim 1, wherein the first-direction line and the second-direction line are coupled at a first node, the third-direction line and the fourth-direction line are coupled at a second node, and a projection of the conductive layer on the first surface is formed so that the first node and second node are interlaced with each other.

5. The touch panel according to claim 1, wherein there are a plurality of the first-direction lines equally spaced, a plurality of the second-direction lines equally spaced, a plurality of the third-direction lines equally spaced, and a plurality of the fourth-direction lines equally spaced.

6. The touch panel according to claim 1, wherein the first-direction line is provided with a plurality of the curves equally spaced, the second-direction line is provided with a plurality of the curves equally spaced, the third-direction line is provided with a plurality of the curves equally spaced, and the fourth-direction line is provided with a plurality of the curves equally spaced.

7. The touch panel according to claim 1, wherein a projection of the conductive layer on the first surface is formed into grid units, and each of the grid units is provided with at least one of the curves.

8. The touch panel according to claim 7, wherein each of grid sides of the grid unit is provided with at least one of the curves.

9. The touch panel according to claim 8, wherein the grid unit has a shape of parallelogram, each of the grid sides of the grid unit is provided with a same number of the curves, and the grid unit is formed in a centrosymmetric structure.

10. The touch panel according to claim 8, wherein the grid unit has a shape of rhombus, each of the grid sides of the grid unit is provided with a same number of the curves, and the grid unit is formed in a non- axisymmetric structure.

11. The touch panel according to claim 8, wherein a length of the curve is ⅛ to ½ of a length of the grid side where the curve is located.

12. A touch device, comprising a touch panel, wherein the touch panel comprises:
a substrate, comprising a first surface; and
a conductive layer, formed on the first surface and comprising a first conductive layer and a second conductive layer spaced apart from each other, the first conductive layer being provided with a first-direction line and a second-direction line coupled to each other, and the second conductive layer being provided with a third-direction line and a fourth-direction line coupled to each other,
wherein at least one of the first-direction line, the second-direction line, the third-direction and the fourth-direction line is provided with a plurality of curves.

13. The touch device according to claim 12, wherein a projection of the curve on the first surface is non-linear.

14. The touch device according to claim 12, wherein the conductive layer further comprises an insulating layer, and
wherein the first conductive layer is coated on the first surface, the insulating layer is disposed on a surface of the first conductive layer away from the first surface, and the second conductive layer is disposed on a surface of the insulating layer away from the first conductive layer, so that the second conductive layer is spaced apart from the first conductive layer.

15. The touch device according to claim 12, wherein the first-direction line and the second-direction line are coupled at a first node, the third-direction line and the fourth-direction line are coupled at a second node, and a projection of the conductive layer on the first surface is formed so that the first node and second node are interlaced with each other.

16. The touch device according to claim 12, wherein there are a plurality of the first-direction lines equally spaced, a plurality of the second-direction lines equally spaced, a plurality of the third-direction lines equally spaced, and a plurality of the fourth-direction lines equally spaced.

17. The touch device according to claim 12, wherein the first-direction line is provided with a plurality of the curves equally spaced, the second-direction line is provided with a plurality of the curves equally spaced, the third-direction line is provided with a plurality of the curves equally spaced, and the fourth-direction line is provided with a plurality of the curves equally spaced.

18. The touch device according to claim 12, wherein a projection of the conductive layer on the first surface is formed into grid units, and each of the grid units is provided with at least one of the curves.

19. The touch device according to claim 18, wherein each of grid sides of the grid unit is provided with at least one of the curves.

20. The touch device according to claim 19, wherein the grid unit has a shape of parallelogram, each of the grid sides of the grid unit is provided with a same number of the curves, and the grid unit is formed in a centrosymmetric structure.
